(19) United States
(12) Patent Application Publication
(10) Pub. No.: US 2013/0208575 A1
(43) Pub. Date: Aug. 15, 2013

(54) REMOTELY DEACTIVATED ALARM CLOCK

(71) Applicant: Paul C. Sammut, Hoboken, NJ (US)

(72) Inventor: Paul C. Sammut, Hoboken, NJ (US)

(21) Appl. No.: 13/744,460

(22) Filed: Jan. 18, 2013

Related U.S. Application Data
(60) Provisional application No. 61/597,617, filed on Feb. 10, 2012.

(51) Int. Cl. G04G 13/02

(52) U.S. Cl. CPC G04G 13/021
USPC 368/250

(57) ABSTRACT

Systems and methods for the remote deactivation of a bedside alarm are provided. The system includes an alarm clock adapted to generate a continuing alarm and a deactivation unit located remotely from the alarm clock. The alarm clock displays a deactivation code in one embodiment, while in other embodiments a deactivation code includes the current calendar date. The deactivation unit, typically placed in a separate room, receives a manually-inputted key sequence and wirelessly transmits the key sequence to the alarm clock for validation. The alarm clock interrupts operation of the continuing alarm when the key sequence matches the deactivation code.

### BACKGROUND OF THE INVENTION

The present invention relates to an alarm clock, and more particular, to a remotely deactivated alarm clock.

Alarm clocks almost universally include an external switch to disable an alarm. For example, the external switch can include a slider or a pushbutton prominently positioned on the alarm clock housing. Many alarm clocks additionally include a snooze feature to deactivate the alarm for a temporary period of time, typically on the order of several minutes. Because a person need only depress a bedside switch to deactivate the alarm, however, many alarm clocks fail to adequately awaken the individual against the temptation to simply return to sleep.

A number of alarm clocks have been proposed in an attempt to overcome these shortcomings. For example, one proposed alarm clock includes a housing having multiple pushbuttons that illuminate in a random sequence. The alarm is deactivated after the user depresses the pushbuttons in the order illuminated. Another proposed construction includes a manual pushbutton separate from the alarm clock housing. According to this construction, the alarm is deactivated in response to depression of the pushbutton for an extended period of time, for example twelve seconds.

Despite their advantages, alarm clocks according to these constructions have failed to gain widespread acceptance. Accordingly, there remains a continued need for an improved system and method to overcome the tendency to return to sleep after deactivating the alarm, while also offering robust protections against attempts to disable the alarm by unplugging the alarm clock or by disabling the alarm shortly in advance of the scheduled alarm time.

### SUMMARY OF THE INVENTION

Systems and methods for the remote deactivation of a bedside alarm are provided. According to one embodiment, the system includes an alarm clock adapted to generate a continuing alarm signal and a deactivation unit located remotely from the alarm clock. The alarm clock displays a deactivation code in one embodiment, while in other embodiments a deactivation code includes the current calendar date. The deactivation unit receives a manually-inputted key sequence and wirelessly transmits the key sequence to the alarm clock for validation. The alarm clock interrupts the continuing alarm signal when the key sequence matches a valid deactivation code.

According to another embodiment, the alarm clock is a bedside unit including an alarm device and a processor, and the deactivation unit includes a control panel having a plurality of physical or virtual keys. The processor is adapted to activate the alarm device at a scheduled alarm time, and is further adapted to deactivate the alarm device in response to a key sequence matching the current deactivation code. The deactivation code can be randomly generated in some embodiments, being valid for only a single deactivation of the alarm device. In addition, the alarm clock can include a battery to prevent deactivation of the alarm device by unplugging the alarm clock.

According to still another embodiment, a method for deactivating an alarm is provided. The method includes providing a deactivation unit that is remote from an alarm clock, receiving a manually-inputted key sequence at the deactivation unit, validating, using a processor, the manually-inputted key sequence, and deactivating an audible alarm signal at the alarm clock in response to the validation of the manually-inputted key sequence. The method can further include receiving a snooze command to interrupt operation of the audible alarm signal, and disabling the snooze command after a predetermined number of snooze commands have been received at the alarm clock.

According to yet another embodiment, an alarm clock lock-down method is provided. The lock-down method includes providing an alarm clock adapted to generate an audible alarm signal at a scheduled alarm time, receiving an alarm disable command prior to the scheduled alarm time, determining, using a processor, whether the alarm disable command is received within a lock-down period prior to the scheduled alarm time, and activating the audible alarm signal at the scheduled alarm time if the alarm deactivation command is received within the lock-down period. If the alarm disable command is received prior to the lock-down period, the method can include disabling the scheduled alarm until subsequently enabled by the user.

These and other features and advantages of the present invention will become apparent from the following description of the invention in accordance with the accompanying drawings and appended claims.

### BRIEF DESCRIPTION OF THE DRAWINGS

FIG. 1 is a perspective view of an alarm clock system.

FIG. 2 is a schematic diagram of the alarm clock system of FIG. 1.

FIG. 3 is a flow chart illustrating alarm clock operation.

FIG. 4 is a flow chart illustrating the alarm clock lock-down feature.

### DETAILED DESCRIPTION OF THE CURRENT EMBODIMENTS

### I. Alarm Clock System

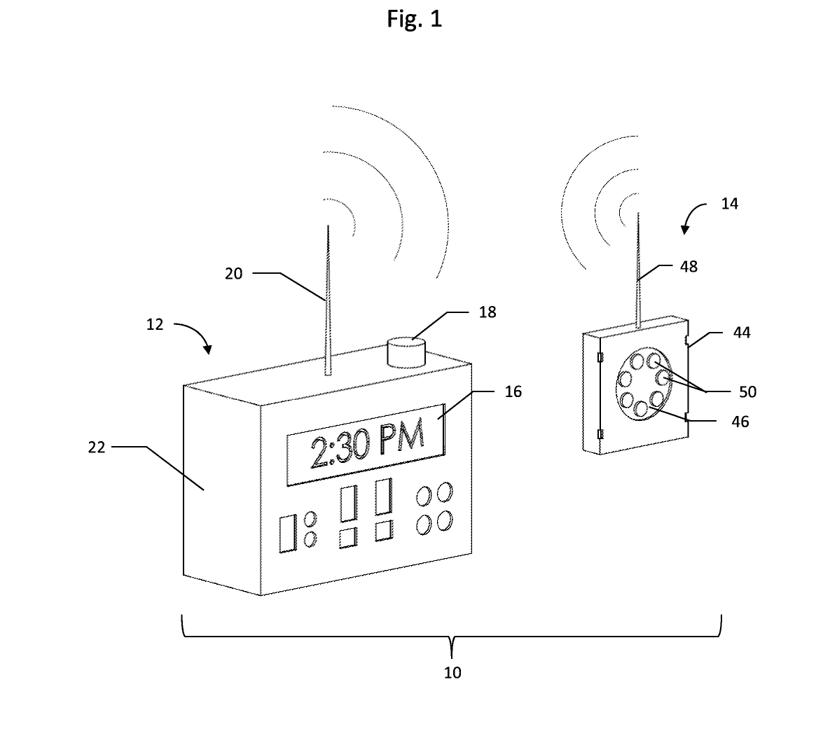

An alarm clock system in accordance with one embodiment is illustrated in FIG. 1 and generally designated 10. The alarm clock system 10 includes an alarm clock 12, for example a bedside alarm clock, and a deactivation unit 14 located remotely from the alarm clock 12. The alarm clock 12 includes a time display 16 to provide the user with a display of the time and any other pertinent information, and one or more input devices 18 to designate a scheduled alarm time, activate/deactivate the alarm, and/or snooze or interrupt the alarm. When the alarm is enabled, the alarm clock 12 will generate an audible alarm signal at the scheduled alarm time. Conversely, when disabled, the alarm clock 12 will not generate an audible alarm signal at the scheduled alarm time. As set forth below, the alarm clock 12 is adapted to deactivate the audible alarm signal in response to the deactivation unit 14 receiving a manually-inputted deactivation code.

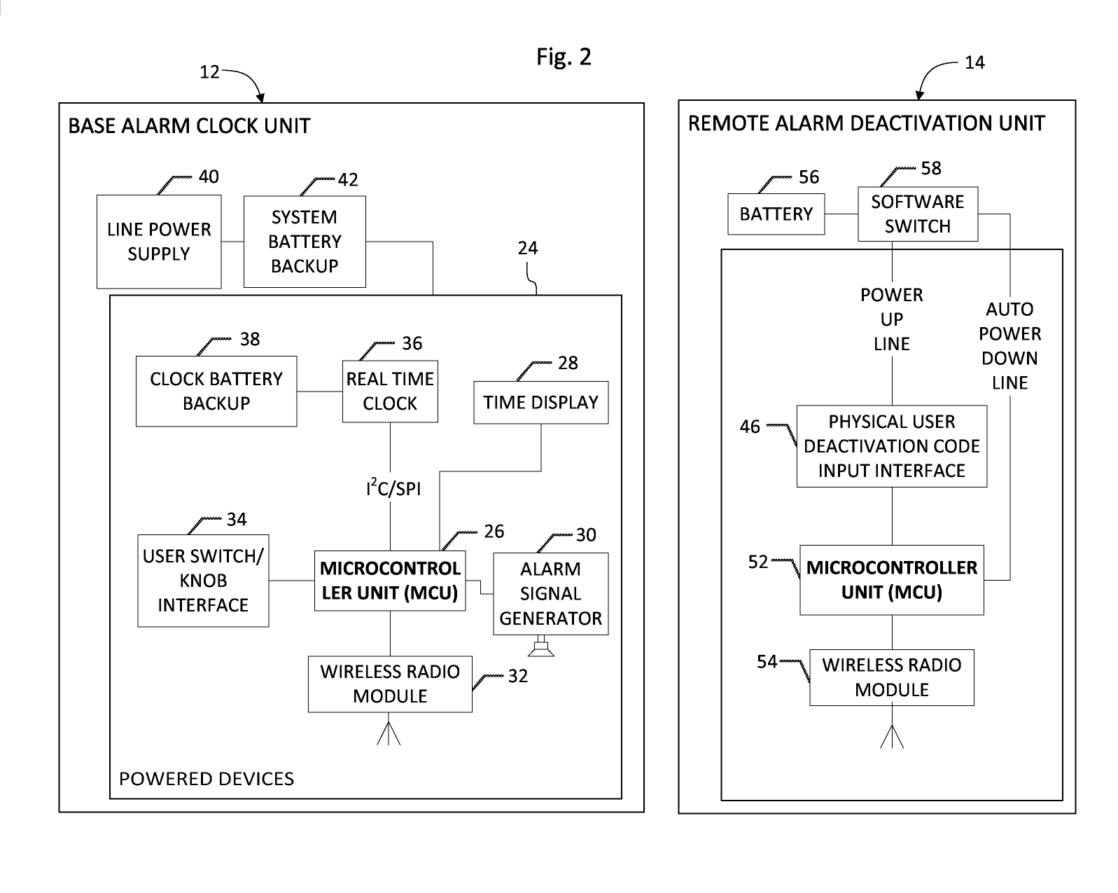

As also shown in FIG. 1, the alarm clock 12 includes an antenna 20 and an exterior housing 24. The exterior housing encloses the internal alarm clock components and provides a structure on which to mount and properly orient the display 16. Referring now to FIG. 2, the electrical system 24 includes a processor 26, a display system 28, an alarm device 30, a wireless radio module 32, a user interface 34, a real time clock 36, and a clock battery backup 38. The electrical system 24 can be powered by an AC-DC electrical power supply 40 that delivers the correct voltage and power capacity to power all the electrical components of the alarm clock 12. In one embodiment, a system battery backup 42 can be used. This allows for uninterrupted power to all alarm clock electrical components in the case of a line power failure or a half-awaken user trying to improperly deactivate the alarm signal by unplugging the alarm clock 12.

The processor 26 can include a microcontroller unit (MCU), an application specific integrated circuit (ASIC), a field-programmable gate array (FPGA), or other device operable to execute machine readable instructions. The time display 28 can include four 7-segment numerical LEDs that can display minutes and hours, along with a visual indicator for AM/PM, and further optionally the deactivation code. The display system 28 can also be used to display a menu mode that the user may enter and configure. In another embodiment, the display system 28 can be a graphic OLED display to display the time and any other possible pertinent information, including for example a deactivation code or a numeral operation that, when solved by the user, reveals the deactivation code. The alarm device 30 can be any device adapted to generate a continuing audible alarm signal beginning at the scheduled alarm and ending when deactivated. For example, the alarm device can include a 1 kHz sine-wave sent through a driver to a piezoelectric buzzer. Alternatively, the alarm device can include a random stream of high logic pulses that drive a transistor connected to a push type solenoid that pushes the plunger on a concierge bell. As the term is used herein, a ‘continuing’ audible alarm signal includes both continuous (i.e. uninterrupted) tones and discontinuous (i.e., interrupted) tones, including repeating beeps, for example. The alarm signal can also include a radio broadcast in other embodiments.

As noted above, the alarm clock electrical system 24 includes a wireless radio module 32. The wireless radio module 32 includes a 433 MHz radio link in the present embodiment, and is operable to wirelessly receive the deactivation code from the deactivation unit 14. In another embodiment, the deactivation unit 14 can utilize the home power wiring to transmit the deactivation code to the alarm clock 12. In either embodiment, the transmitted alarm deactivation code can contain a header packet that uniquely identifies the alarm clock 12 that the specific deactivation unit 14 is trying to communicate with. This allows two or more alarm clock systems 10 to operate in the same household without causing interference.

The user interface 34 includes a combination of switches, knobs, buttons and/or touchscreens to enable a user to input a desired alarm time, or times, for any day, or specific day, or group of days. The processor 26 stores this information in computer readable memory. The user also has the ability to enable the alarm at the scheduled time through the user interface 34. In one embodiment, the user can use her left hand to manipulate a momentary DPST switch. One pole of this switch activates alarm time setting mode, and the other pole activates time setting mode. With the user's right hand, manipulation of a knob can either advance or retreat the time. Note that there are many other ways that time and alarm time setting can be achieved by one skilled in the art.

The alarm clock electrical system 24 additionally includes a real time clock module 36 to calculate and store the date and time. The real time clock module 36 may be connected to the processor 26 via any supported data transfer protocol, such as the I2C Dallas two wire protocol or SPI. The real time clock module 36 provides the microcontroller 26 with the current date and time. As noted above, the real time clock module 36 can have a battery backed time keeping feature 38, as shown as one embodiment detailed in FIG. 2. In embodiments where the alarm clock 12 includes a system battery backup 42 (different form the clock battery backup 38), a manual shut-off switch may be implemented. This allows the user to manually shut off the alarm clock 12, such as in the case when the user desires to store the alarm clock 12, or the deactivation code cannot be remembered. The manual shut-off switch may be constructed in such a way that it cannot easily be manipulated, and thus preventing a half-awake user trying to incorrectly deactivate an alarm via the manual shut-off switch. In one embodiment, this desired effect can be achieved by constructing a manual shut-off switch that requires the use of a common house-hold tool, such as a screw driver.

Referring again to FIG. 1, the alarm clock system 10 includes a deactivation unit 14 that is physically separate from the alarm clock 12. For example, the deactivation unit 14 can be a table-top unit or a wall-mounted unit placed in a separate room from the alarm clock 12. The deactivation unit 14 generally includes a housing 44, a control panel 46, and an antenna 48 for communicating with the counterpart alarm clock 12. In one embodiment, the control panel 46 includes a numeric keypad with pushbuttons 50 corresponding to numbers 0 through 9. In another embodiment, the control panel 46 includes a touch screen, for example a capacitive or resistive touch screen, including virtual pushbuttons corresponding to numbers 0 through 9. In still another embodiment, the control panel 46 includes a series of illuminated pushbuttons that momentarily illuminate in a specified order to reveal the current deactivation code.

Referring again to FIG. 2, the control panel 46 is electrically coupled to an internal processor 52, for example an MCU, an ASIC or an FPGA. This processor 52 is electrically coupled to a wireless radio module 54 for communicating the entered key sequence to the alarm clock wireless radio module 32 over the 433 MHz radio link. The deactivation unit 14 can be powered by any kind of battery 56, rechargeable or non-rechargeable. The deactivation unit 14 can also be powered by an AC-DC rectifier plugged into an outlet. In the case of battery use, a smart software switch system 58 can be incorporated in the deactivation unit 14 to power up the system when the user presses an “on” button, and then automatically power down the system after a predetermined amount of time in an idle state. This can prevent accidental discharge of the battery 56 in the case the user forgot to turn off the remote alarm deactivation panel.

As noted above, the alarm clock 12 is operable to deactivate the alarm device 30 when a valid deactivation code is received at the deactivation unit 14. The deactivation code and the deactivation unit 14 can be any process and device that engages the user by requiring at least moderate level of mental thought that facilitates further waking, all the while not being an excessively taxing and long process that might impinge on the user's normal wake-up routine. For example, the deactivation code can include the current date entered in 6 digit form such as MMDDYY. This code is then wirelessly sent to the alarm clock 10. If the 6 digit code matches the current date as determined by the real time clock module 36, the alarm signal is deactivated and the waking user can start the day. In another embodiment, the alarm deactivation code can include a 4 digit number flashed on the hours and minutes display for 1 second every 3 seconds on the alarm clock 12. After the sleeping user has been woken by the alarm signal, the user must look at the alarm clock 12 and memorize the 4 digit number deactivation code that is being flashed every 3 seconds. The user must then rise out of bed, walk to the remote deactivation unit 14 and enter the 4 digit deactivation code into the numeric keypad 46. The deactivation code is then wirelessly sent to the base alarm clock and if correct, the alarm signal is deactivated. In still another embodiment, there can be a specific number of button illuminations, for example six button illuminations, that the user must observe at the control panel 46, and then press, to deactivate the alarm. After the button illumination sequence is complete, the remote alarm deactivation microcontroller unit can verify if the button presses correctly matched the illuminated button sequence. If there is a match, the deactivation unit 14 can send a deactivation signal to the alarm clock 12. The alarm clock 12 can then deactivate the alarm signal and the user can continue on with her day.

### II. Alarm Clock Deactivation Method

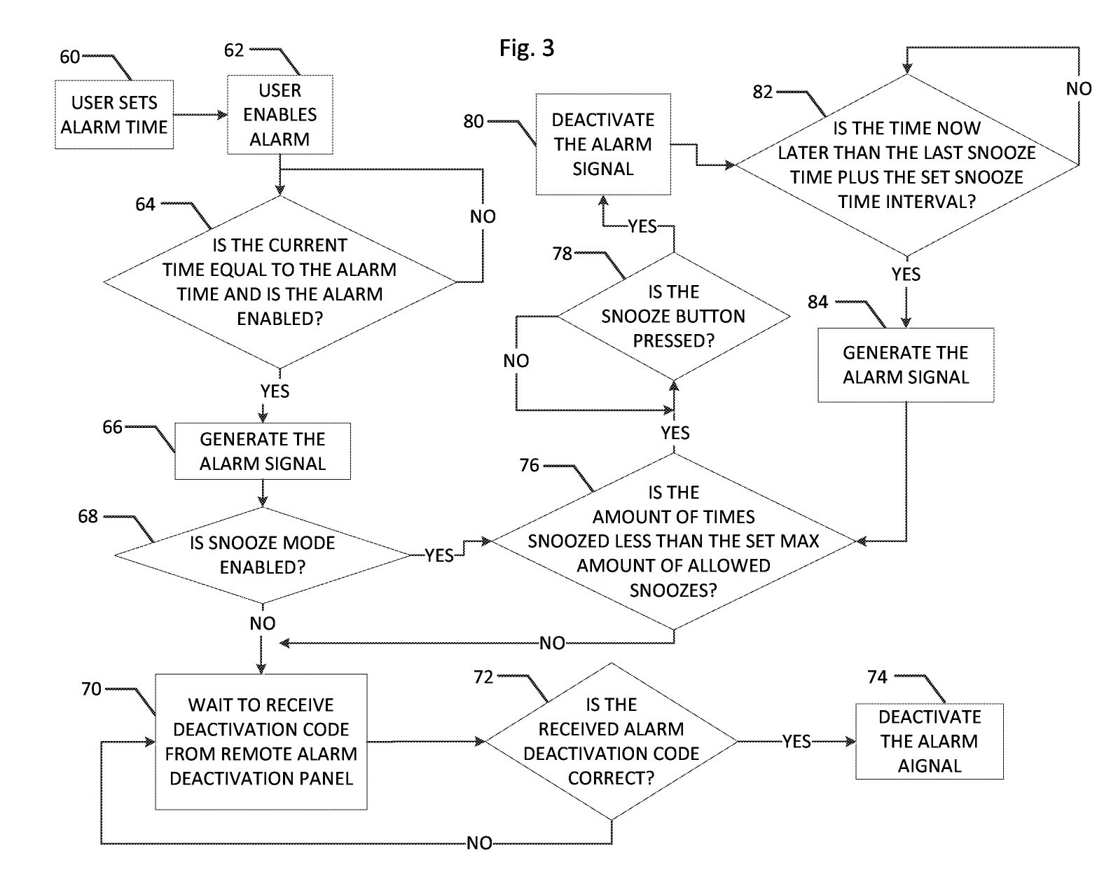

A method for the remote deactivation of an alarm clock is illustrated in the flow chart of FIG. 3. At step 60, the user sets the scheduled alarm time, and at step 62, the user enables the alarm. At decision step 64, the alarm clock processor 26 determines if the current time is equal to the scheduled alarm time. This can be done periodically (for example every second) by checking if the current time equals the scheduled alarm time. If the current time is equal to the scheduled alarm time, the alarm device 30 generates a continuous audible alarm signal to wake the user at step 66. If the snooze mode is not enabled at step 68, the alarm clock processor 26 waits for a deactivation code from the wireless radio module 32 at step 70. At decision step 72, the alarm clock processor 26 validates the deactivation code. Alternatively, the deactivation unit processor 54 validates the deactivation code, and transmits the result to the alarm clock 12. In either instance, the deactivation code is entered as a key sequence. If the key sequence matches the current deactivation code, the processor 26 ceases operation of the alarm device 26 at step 74. If the key sequence does not match the current deactivation code, the alarm device 30 continues to generate the audible alarm signal.

Referring again to FIG. 3, the alarm clock system 10 additionally includes a snooze mode to allow the user to interrupt operation of the alarm signal a finite number of times. The user can enable or disable the snooze mode while also setting the maximum number of allowed requests and the snooze time interval. After the alarm conditions have been met, the alarm signal has been generated, and the user has opted to previously enable the snoozing feature, the user may press a snooze button that will suspend the alarm for a length of time equal to the snooze time interval. For example, if the snooze mode is enabled at step 68, the alarm clock processor 26 determines if the cumulative number of snooze requests is less than the maximum number of allowed snooze requests at step 76. If the number of snooze requests is greater than the maximum number of allowed snooze requests, the alarm device 30 continues to generate the alarm signal until manually deactivated at the deactivation panel 14. If however the number of snooze requests is less than or equal to the maximum number of allowed snooze requests, and if the snooze button is pressed at step 78, the processor 26 temporarily interrupts operation of the alarm signal generator 26 at step 80. After the snooze period has lapsed as determined at step 82, the alarm device 26 reactivates at step 84.

Further optionally, the method of FIG. 3 includes an alarming mode, in which all the switches and knobs that manipulate all alarm setting or time setting functions are disabled. If the snooze feature was enabled, this alarming mode will occur after the maximum amount of allowed snoozes is exhausted. If the snooze feature was not enabled, or was not included in the embodiment, this event will occur immediately following the generation of the alarm signal, which occurs when a user set alarm condition is met. At this point, the user cannot deactivate the alarm signal from the alarm clock. To deactivate the alarm signal emanating from the alarm clock, the user must enter the correct alarm deactivation code in the remote alarm deactivation panel. To do this, the user must rise out of bed, and walk to wherever the user placed the remote alarm deactivation panel. The placement of the remote alarm deactivation panel may be in a location where the waking user will usually walk to as a part of the user's normal wake-up routine, such as the bathroom. Once the user arrives at the remote alarm deactivation panel, the user must enter a key sequence corresponding to the current alarm deactivation code. As noted above, the current alarm deactivation code can include the current date, a numerical value displayed at the alarm clock, a mathematical operation (e.g., an addition of two integers). As noted above, the current alarm deactivation code can further include a series of pushbuttons that illuminate in a specified order. Once the key sequence is entered, the deactivation unit 14 or alarm clock 12 validates the key sequence, terminates the alarm signal, and enables the switches and knobs that manipulate the alarm setting and time setting functions.

In another embodiment, the method of remote deactivation includes a lock-down feature. The lock-down feature can prevent a user from waking a short time before the scheduled alarm time and in a half-awaken state and deactivating, or setting further back, the alarm time in the hope of sleeping further past the set alarm time. The lock-down feature allows the user to define a length of time called the lock-down period (e.g., thirty minutes). When the alarm has been enabled, and the current time equals the scheduled alarm time less the lock-down period, the alarm clock goes into lock-down mode. When this happens, the switches and knobs that manipulate all alarm and time setting functions are disabled.

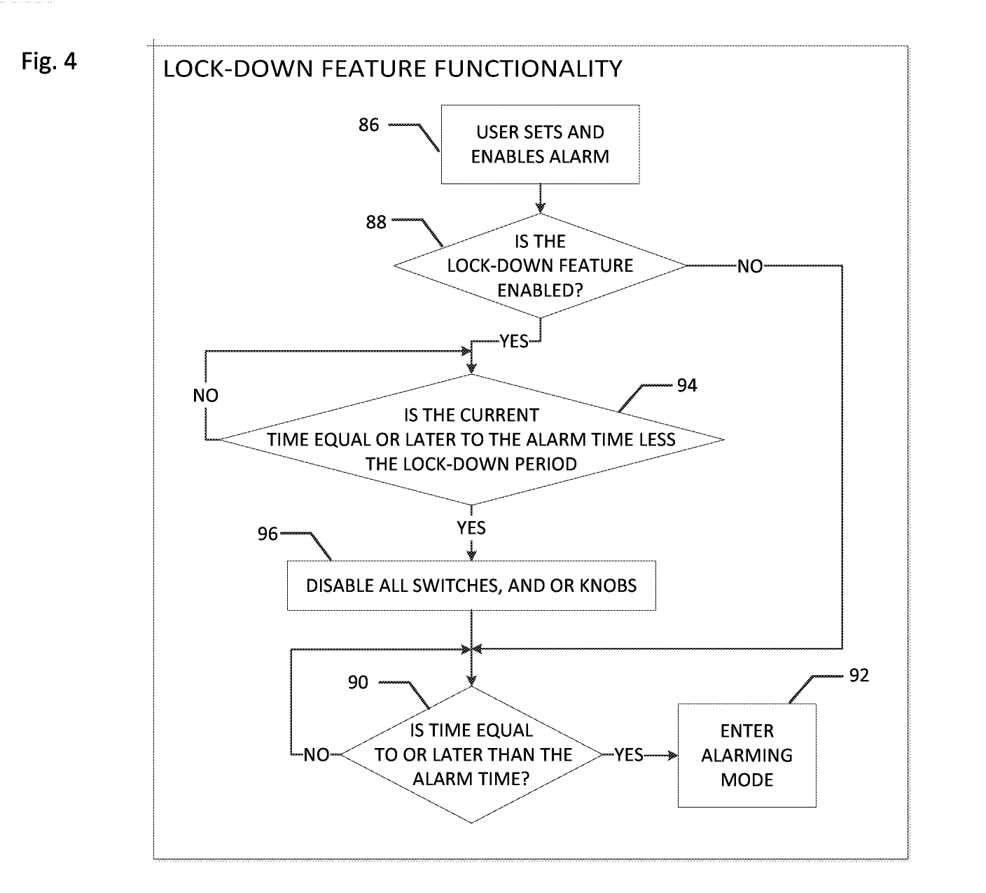

More particularly, and with reference to FIG. 4, the user enables the alarm at step 86. At step 88, the alarm clock processor 26 determines if the lock-down feature is currently enabled. If the lock-down feature is not enabled, the alarm clock processor 26 awaits the scheduled alarm time at step 90 and enters the alarming mode at step 92. If the lock-down feature is enabled, the alarm clock processor 26 determines if the current time is equal to or later than the scheduled alarm time less the lock-down period at decision step 94. If the current time is not within the lock-down period, the user is allowed to change the scheduled alarm time or disable the alarm. If however the current time is within the lock-down period, all switches are disabled at step 96, and the user is prevented from changing the scheduled alarm time or disabling the alarm. The alarm clock processor 26 awaits the scheduled alarm time at step 90 and enters the alarming mode at step 92.

It must be noted that there can be an occurrence where the user who enabled the lock-down feature will fully rise out of bed before the scheduled alarm time, and will want to leave the house before the alarm goes off. The lock-down feature can take this specific event into account. It can allow the user to disable the alarm without having to wait for the set alarm time. This can be done by simply going to the remote alarm deactivation unit and inputting the deactivation code. After the alarm clock received the correct deactivation code, it will then exit lock-down mode and automatically disable the pending alarm.

The lock-down feature can additionally include a grace-mode. A situation might arise where the user accidentally sets and enables an alarm time that satisfies the lock-down mode condition while lock-down is enabled. In this situation, the alarm clock will enter lock-down mode, and the user will have to walk to the remote alarm deactivation panel and punch in the correct deactivation code. To prevent this undesired event from happening, a grace-mode feature may be implemented. Within the lock-down-grace-period, the user will have a predetermined grace period, such as, but not limited to, 30 seconds, following the setting of any alarm time, in which, the lock-down mode will be suspended even in the case of the current time being later than the alarm time less the lock-down period. This will give the user 30 seconds to fix the incorrectly input alarm time before enacting the change.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. An alarm clock system comprising:
an alarm clock adapted to generate a continuing alarm; and
a deactivation unit separate from the alarm clock and including a control panel, wherein the alarm clock is operable to silence the continuing alarm in response to the control panel receiving a manually-inputted deactivation code.

2. The alarm clock system of claim 1 wherein:
the control panel includes a keypad; and
the deactivation code includes a key sequence for entry on the keypad.

3. The alarm clock system of claim 2 wherein the deactivation code is periodically updated to include a new key sequence.

4. The alarm clock system of claim 1 wherein the deactivation code is displayed at the alarm clock or at the deactivation unit.

5. The alarm clock system of claim 1 wherein the deactivation code is based on a calendar date.

6. The alarm clock system of claim 1 further including a wireless data link between the alarm clock and the deactivation unit.

7. The alarm clock system of claim 1 further including a snooze switch to interrupt operation of the continuing alarm, wherein the alarm clock is operable to disable the snooze switch after a predetermined number of interruptions.

8. An alarm deactivation method comprising:
providing a deactivation unit that is remote from an alarm clock;
receiving a manually-inputted key sequence at the deactivation unit;
validating, using a processor, the manually-inputted key sequence; and
deactivating an audible alarm on the alarm clock in response to the validation of the manually-inputted key sequence.

9. The method according to claim 8 further including:
receiving a snooze command at the alarm clock after activation of the audible alarm; and
disabling the snooze command after a predetermined number of snooze commands have been received at the alarm clock.

10. The method according to claim 8 further comprising displaying, at the alarm clock or at the deactivation unit, the deactivation key sequence.

11. The method according to claim 8 wherein the deactivation key sequence is based on a calendar date.

12. The method according to claim 8 wherein the deactivation key sequence is based on a numerical operation performed by a user.

13. The method according to claim 8 wherein validating the manually-inputted key sequence includes comparing the manually-inputted key sequence with a key sequence stored in computer readable memory.

14. A method for controlling an alarm setting, the method comprising:
providing an alarm clock configured to generate an audible alarm at a scheduled alarm time;
receiving an alarm deactivation command at the alarm clock prior to the scheduled alarm time;
determining, using a processor, whether the alarm deactivation command is received within a lock-down period prior to the scheduled alarm time; and
activating the audible alarm at the scheduled alarm time if the alarm deactivation command is received within the lock-down period.

15. The method according to claim 14 further including:
providing a deactivation unit separate from the alarm clock;
receiving a manually-inputted key sequence at the deactivation unit;
validating, using a processor, the manually-inputted key sequence; and
deactivating the audible alarm in response to the validation of the manually-inputted key sequence.

16. An alarm clock system comprising:
a deactivation unit including a control panel; and
an alarm clock separate from the deactivation unit and including:
an alarm device adapted to generate a continuing alarm,
a time display adapted to display a deactivation code, and
a processor configured to activate the alarm device at a scheduled alarm time and deactivate the alarm device in response to the control panel receiving the deactivation code from a user.

17. The alarm clock system of claim 16 wherein the control panel includes a numerical keypad for receipt of a key sequence.

18. The alarm clock system of claim 17 wherein the deactivation device is configured to transmit the key sequence to the alarm clock.

19. The alarm clock system of claim 18 wherein the processor is configured to validate the key sequence against the deactivation code displayed on the time display.

20. The alarm clock system of claim 16 wherein the deactivation code is generated using a random number generator.
